(19) United States
(12) Patent Application Publication
(10) Pub. No.: US 2005/0008747 A1
(43) Pub. Date: Jan. 13, 2005

(54) Method of forming a sugarless coating on chewing gum

(76) Inventors: David G. Barkalow, Deerfield, IL (US); Michael A. Reed, Merrillville, IN (US); Robert B. Friedman, Chicago, IL (US); Elena S. Mirzoeva, Cary, IL (US); Julius W. Zuehlke, Chicago, IL (US); Robert J. Yatka, Orland Park, IL (US)

Correspondence Address: WRIGLEY & DREYFUS 28455;BRINKS HOFER GILSON & LIONE, P.O. BOX 10395, CHICAGO, IL, 60610, US

(21) Appl. No.: 10/617,905

(22) Filed: Jul. 11, 2003

(51) Int. Cl. A01K 1/00

(52) U.S. Cl. 426/548

(57) ABSTRACT

A method of forming a sugarless coating on chewing gum cores comprises: providing chewing gum cores; providing a coating syrup comprising one or more sugarless sweeteners; providing a dusting mix comprising about 20% to about 60% of a bulk sweetener selected from the group consisting of malitol, hydrogenated isomaltulose, lactitol, sorbitol and mixtures thereof and about 40% to about 80% filler; and applying a plurality of layers of the coating syrup and a plurality of layers of the dusting mix to the chewing gum cores to form a sugarless coating on the gum cores.

### BACKGROUND OF THE INVENTION

The present invention relates to chewing gum, and more particularly to a method of making chewing gum products with a sugarless coating.

Coated chewing gum products are well known. Many such products are made with a sugarless coating. For example, products that are designed to not promote tooth decay do not use fermentable sugars in the product, or in coatings on the product. Instead, sugarless sweeteners such as sorbitol, maltitol, xylitol, erythritol, lactitol, hydrogenated isomaltulose and others are used in the product.

While a hard, crunchy coating is desirable, it has proven difficult to make such coatings when using sugarless sweeteners. Considerable effort and patent activity has taken place in this area. For example, see U.S. Pat. Nos. 4,238,510 and 4,317,838 to Cherukuri et al. and U.S. Pat. No. 5,571,547 to Serpelloni et al.

One of the problems faced by chewing gum manufacturers is cost and availability of sugarless sweeteners. For example, maltitol, which gives a good coating, is fairly expensive, and sources of high purity powdered maltitol may be limited. Some sugarless sweeteners may be less expensive, but it is difficult to form high quality coatings with them. Thus, there is a need for a method of making high quality coatings on chewing gum at a reduced cost, and preferably from materials that are plentiful.

### BRIEF SUMMARY OF THE INVENTION

A method of forming a sugarless coating on chewing gum has been discovered that makes use of a high quantity of less expensive filler material and yet still provides a quality coating.

In one aspect, the invention is a method of forming a sugarless coating on chewing gum cores comprising: providing chewing gum cores; providing a coating syrup comprising one or more sugarless sweeteners; providing a dusting mix comprising about 20% to about 60% of a bulk sweetener selected from the group consisting of malitol, hydrogenated isomaltulose, lactitol, sorbitol and mixtures thereof and about 40% to about 80% filler; and applying a plurality of layers of the coating syrup and a plurality of layers of the dusting mix to the chewing gum cores to form a sugarless coating on the gum cores.

The use of a large quantity of filler in the dusting mix reduces the cost of the coating, yet the method of the present invention provides a way to use such a filler and still produce a quality gum coating. In preferred embodiments of the invention, more readily available forms of sugarless sweeteners are used, which is a further benefit to chewing gum manufacturers.

### DETAILED DESCRIPTION OF THE INVENTION AND PREFERRED EMBODIMENTS

The term “chewing gum” as used herein also includes bubble gum and the like. Unless indicated otherwise, all percentages are given in weight percent.

In the past, suspension coatings with calcium carbonate have been used for an antacid gum made with sugar. Sugar with its naturally sweet taste masked some of the off-taste resulting from the use of high levels of calcium carbonate. With the advent of new coating technologies using less sweet sugarless sweeteners instead of sugar, the sweet taste of the coating is significantly reduced. In some coatings where xylitol is used, the xylitol is sufficiently sweet as a coating, but other polyols such as maltitol, hydrogenated isomaltulose, sorbitol and erythritol, are not. When the coating contains calcium carbonate, the polyols may lack sufficient sweetness to give a good tasting product. As a result, high-intensity sweeteners needed to be added to the coating containing calcium carbonate to give a high-quality, consumer-acceptable product.

During typical sugarless coating operations, coating syrups made with maltitol, hydrogenated isomaltulose, sorbitol and lactitol are applied and dried with air to form a hard crunchy shell. As the coating dries, it has a tendency to become sticky and cause pellets to stick together or to the side of the coating pan. This would normally require additional air drying between syrup applications and extend the coating process time. To overcome this, less liquid syrup could be added per application, which would also extend the coating process time.

The other option is the use of a dry charge or dusting material of the powdered polyol to absorb moisture and allow faster drying. In addition, to allow the powdered polyol to spread more evenly over the bed of gum centers, an anticaking agent is sometime added to the dry charge. However, the level of anticaking agent is usually kept low to reduce any taste problems due to use of this anticaking agent.

In the present invention, a significant amount of filler such as calcium carbonate is used as part of a dry charge or dusting material in a chewing gum coating. In previous patents, it is disclosed that calcium carbonate can be used in the coating syrup to coat or pan chewing gum products. In other patents, calcium carbonate is used as an anticaking agent in the dry charge or dusting material, but it is used at a low level.

In the present invention, high levels of calcium carbonate and/or other fillers are used in the dry charge or dusting material for chewing gum coatings. The level of filler used in the dry charge material is about 40% to about 80%, preferably 45% to 55%, and more preferably 50% of the dry charge material. Since a dry charge material is typically about 12% of the pellet coating, the coating will contain about 5% to about 10% filler, and preferably about 6-7% of the coating. The remaining dry charge material will be about 20% to about 60% bulk sweetener, such as maltitol, hydrogenated isomaltulose, sorbitol, or lactitol. The polyol used in the dry charge should be the same polyol used to make the syrup coatings that are used in the coating. A preferred dry charge will have 50% calcium carbonate and 50% maltitol. The particle size of the polyol and filler should be small enough that they do not impart a noticeable grainy mouth feel when the product is consumed.

For chewing gum products, calcium carbonate is the most preferred filler material. This is mostly due to the fact that the most common inert filler in chewing gum base is calcium carbonate. Calcium carbonate, along with talc, which is used in talc bases that are used for some types of gum products that use food acids to give tartness to flavors, have been used as fillers in gum base and gum products for many years.

Although chewing gum hard shell coatings of sugar or xylitol are not conventionally made with a dry charge or dusting mix, there may be instances where there could be an advantage to using the present invention in these types of coatings. With other sugars, such as dextrose, and polyols, use of a dry charge is needed to reduce the stickiness of the liquid polyol syrup coating and can provide a faster buildup of the coating. The most common polyols that use a dry charge for coating of chewing gum are maltitol, hydrogenated isomaltulose, sorbitol and lactitol, and preferably maltitol.

The filler used in the present invention can be calcium carbonate, magnesium carbonate, talc, ground limestone, magnesium or aluminum silicates, titanium dioxide, mono-, di-, or tricalcium phosphate, cellulose polymers, or combinations. Preferably, calcium carbonate and talc should be used.

In the present invention, it has been found that a level of calcium carbonate, talc or other fillers of about 40% to about 80% of the dry charge material and 5-10% in the coating can be used, but surprisingly a high-quality consumer-acceptable coating can still be made. At this level, the filler does not serve as an anticaking agent, but as a filler for the coating. It has been found that this higher level of use not only gives the advantage of lower cost by replacing the polyol, but also gives some technological advantages. The resulting product has a crunchier coating, has increased corner strength, resulting in less corner chipping. In processing with this high level of filler, the coating time is also reduced, thus giving additional cost savings. Also, at this 5-10% level, the filler, which is preferably calcium carbonate, does not contribute any sensory defects. Additional test have also shown that the finished product has improved shelf life when stored under high humidity conditions.

After a liquid coating syrup is applied to the gum centers and allowed to spread, the dry charge is applied and allowed to spread over the liquid coated centers and absorb some of the moisture. Then drying air is applied to dry the pellets before the next syrup application. Generally, about 40-50 syrups applications are used to make coated chewing gums, and a dry charge is preferably used with the first 12 to 30 syrup applications. Later syrup applications, which are used to build up the coating and to smooth the surface of the pellet, preferably do not use a dry charge. Finally, the last 3-4 syrup applications are usually dried more slowly to give a smooth pellet coating for a quality chewing gum product.

In general, a chewing gum composition typically comprises a water-soluble bulk portion, a water-insoluble chewable gum base portion and typically water-insoluble flavoring agents. The water-soluble portion dissipates with a portion of the flavoring agent over a period of time during chewing. The gum base portion is retained in the mouth throughout the chew.

The insoluble gum base generally comprises elastomers, resins, fats and oils, softeners and inorganic fillers. The gum base may or may not include wax. The insoluble gum base can constitute approximately 5% to about 95% by weight of the chewing gum, more commonly the gum base comprises 10% to about 50% of the gum, and in some preferred embodiments approximately 25% to about 35% by weight, of the chewing gum. In pellet gum center formulations, the level of insoluble gum base may be much higher.

In a particular embodiment, the chewing gum base of the present invention contains about 20% to about 60% by weight synthetic elastomer, about 0% to about 30% by weight natural elastomer, about 5% to about 55% by weight elastomer plasticizer, about 4% to about 35% by weight filler, about 5% to about 35% by weight softener, and optional minor amounts (about 1% or less by weight) of miscellaneous ingredients such as colorants, antioxidants, etc.

Synthetic elastomers may include, but are not limited to, polyisobutylene with GPC weight average molecular weights of about 10,000 to about 95,000, isobutylene-isoprene copolymer (butyl elastomer), styrene-butadiene, copolymers having styrene-butadiene ratios of about 1:3 to about 3:1, polyvinyl acetate having GPC weight average molecular weights of about 2,000 to about 90,000, polyisoprene, polyethylene, vinyl acetate-vinyl laurate copolymers having vinyl laurate contents of about 5% to about 50% by weight of the copolymer, and combinations thereof.

Preferred ranges are: 50,000 to 80,000 GPC weight average molecular weight for polyisobutylene; 1:1 to 1:3 bound styrene-butadiene for styrene-budadiene; 10,000 to 65,000 GBC weight average molecular weight for polyvinyl acetate, with the higher molecular weight polyvinyl acetates typically used in bubble gum base; and a vinyl laurate content of 10-45% for vinyl acetate-vinyl laurate.

Natural elastomers may include natural rubber such as smoked or liquid latex and guayule, as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters such as glycerol esters or partially hydrogenated rosin, glycerol esters of polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing. The preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water-insoluble gum base portion, a typical chewing gum composition includes a water-soluble bulk portion and one or more flavoring agents. The water-soluble portion can include bulk sweeteners, high-intensity sweeteners, flavoring agents, softeners, emulsifiers, colors, acidulants, fillers, antioxidants, and other components that provide desired attributes.

Softeners are added to the chewing gum in order to optimize the chewability and mouth feel of the gum. The softeners, which are also known as plasticizers and plasticizing agents, generally constitute between approximately 0.5% to about 15% by weight of the chewing gum. The softeners may include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Bulk sweeteners include both sugar and sugarless components. Bulk sweeteners typically constitute about 5% to about 95% by weight of the chewing gum, more typically, about 20% to about 80% by weight, and more commonly, about 30% to about 60% by weight of the gum. Sugar sweeteners generally include saccharide-containing components commonly known in the chewing gum art, including but not limited to, sucrose, dextrose, maltose, dextrin, dried invert sugar, fructose, galactose, corn syrup solids, and the like, alone or in combination. Sugarless sweeteners include, but are not limited to, sugar alcohols such as sorbitol, mannitol, xylitol, hydrogenated starch hydrolysates, maltitol, hydrogenated isomaltulose, and the like, alone or in combination.

High-intensity artificial sweeteners can also be used, alone or in combination, with the above. Preferred sweeteners include, but are not limited to, sucralose, aspartame, N-substituted APM derivatives such as neotame, salts of acesulfame, alitame, saccharin and its salts, cyclamic acid and its salts, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Examples of low caloric bulking agents include: polydextrose; oligofructose (Raftilose); inulin (Raftilin); fructooligosaccharides (NutraFlora); palatinose oligosaccharide; guar gum hydrolysate (BeneFiber); or indigestible dextrin (Fibersol). However, other low calorie bulking agents can be used.

A variety of flavoring agents can also be used, if desired. The flavor can be used in amounts of about 0.1 to about 15 weight percent of the gum, and preferably, about 0.2% to about 5% by weight. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

In general, chewing gum is manufactured by sequentially adding the various chewing gum ingredients to a commercially available mixer known in the art. After the ingredients have been thoroughly mixed, the gum mass is discharged from the mixer and shaped into the desired form such as rolling sheets and cutting into sticks, extruding into chunks or casting into pellets, which are then coated or panned.

Generally, the ingredients are mixed by first melting the gum base and adding it to the running mixer. The base may also be melted in the mixer itself. Color or emulsifiers may also be added at this time. A softener such as glycerin may also be added at this time, along with syrup and a portion of the bulking agent. Further parts of the bulking agent are added to the mixer. Flavoring agents are typically added with the final portion of the bulking agent. Other optional ingredients are added to the batch in a typical fashion, well known to those of ordinary skill in the art.

The entire mixing procedure typically takes from five to fifteen minutes, but longer mixing times may sometimes be required. Those skilled in the art will recognize that many variations of the above described procedure may be followed.

After the ingredients are mixed, the gum mass is formed into pellets or balls. Pellet or ball gum is prepared as conventional chewing gum but formed into pellets that are pillow shaped, or into balls. The pellets/balls are used as cores for the coated product. The cores can be sugar or polyol coated or panned by conventional panning techniques to make a unique coated pellet gum. The weight of the coating may be about 20% to about 50% of the weight of the finished product, but may be as much as 75% of the total gum product.

Conventional panning procedures generally coat with sucrose, but recent advances in panning have allowed use of other carbohydrate materials to be used in place of sucrose. Some of these components include, but are not limited to, sugars such as dextrose, maltose and palatinose; or sugarless bulk sweeteners such as xylitol, sorbitol, hydrogenated isomaltulose, erythritol, lactitol, maltitol, and other new polyols (also referred to as alditols) or combinations thereof. The coating may thus be a sugar coating or sugarless. These materials may be blended with panning modifiers including, but not limited to, gum arabic, maltodextrins, corn syrup, gelatin, cellulose type materials like carboxymethyl cellulose or hydroxymethyl cellulose, starch and modified starches, vegetables gums like alginates, locust bean gum, guar gum, and gum tragacanth, insoluble carbonates like calcium carbonate or magnesium carbonate and talc. Antitack agents may also be added as panning modifiers, which allow the use of a variety of carbohydrates and sugar alcohols to be used in the development of new panned or coated gum products. Flavors may also be added with the sugar or sugarless coating to yield unique product characteristics.

As noted above, the coating may contain ingredients such as flavoring agents, as well as dispersing agents, coloring agents, film formers and binding agents. Flavoring agents contemplated by the present invention include those commonly known in the art such as essential oils, synthetic flavors or mixtures thereof, including but not limited to oils derived from plants and fruits such as citrus oils, fruit essences, peppermint oil, spearmint oil, other mint oils, clove oil, oil of wintergreen, anise and the like. The flavoring agents may be used in an amount such that the coating will contain from about 0.2% to about 3% flavoring agent, and preferably from about 0.7% to about 2.0% flavoring agent.

High-intensity sweeteners contemplated for use in the coating include but are not limited to synthetic substances, saccharin, thaumatin, alitame, saccharin salts, aspartame, and N-substituted APM derivatives such as neotame, sucralose and acesulfame-K. The high-intensity sweetener may be added to the coating syrup in an amount such that the coating will contain from about 0.01% to about 2.0%, and preferably from about 0.1% to about 1.0% high-intensity sweetener. Preferably the high-intensity sweetener is not encapsulated.

Dispersing agents are often added to syrup coatings for the purpose of whitening and tack reduction. Dispersing agents contemplated by the present invention to be employed in the coating syrup include titanium dioxide, talc, or any other antistick compound. Titanium dioxide is a presently preferred dispersing agent of the present invention. The dispersing agent may be added to the coating syrup in amounts such that the coating will contain from about 0.1% to about 1.0%, and preferably from about 0.3% to about 0.6% of the agent.

Coloring agents are preferably added directly to the syrup in the dye or lake form. Coloring agents contemplated by the present invention include food quality dyes. Film formers preferably added to the syrup include methyl cellulose, gelatins, hydroxypropyl cellulose, ethyl cellulose, hydroxyethyl cellulose, carboxymethyl cellulose and the like and combinations thereof. Binding agents may be added either as an initial coating on the chewing gum center or may be added directly into the syrup. Binding agents contemplated by the present invention include gum arabic, gum talha (another type of acacia), alginate, cellulosics, vegetable gums and the like, and used at a level of about 1% to about 12% of the coating.

The coating is initially present as a liquid syrup which contains from about 30% to about 80% or 85% of the coating ingredients previously described herein, and from about 15% or 20% to about 70% of a solvent such as water. In general, the coating process is carried out in a rotating pan. Sugar or sugarless gum center tablets to be coated are placed into the rotating pan to form a moving mass.

The material or syrup which will eventually form the coating is applied or distributed over the gum center tablets. Flavoring agents may be added before, during and after applying the syrup to the gum centers. Once the coating has dried to form a hard surface, additional syrup additions can be made to produce a plurality of coatings or multiple layers of hard coating.

In a hard coating panning procedure, syrup is added to the gum center tablets at a temperature range of from about 100° F. (38° C.) to about 240° F. (116° C.). Preferably, the syrup temperature is from about 130° F. (54° C.) to about 200° F. (94° C.) throughout the process in order to prevent the polyol or sugar in the syrup from crystallizing. The syrup may be mixed with, sprayed upon, poured over, or added to the gum center tablets in any way known to those skilled in the art.

In general, a plurality of layers is obtained by applying single coats, allowing the layers to dry, and then repeating the process. The amount of solids added by each coating step depends chiefly on the concentration of the coating syrup. Any number of coats may be applied to the gum center tablet. Preferably, no more than about 75-100 coats are applied to the gum center tablets. The present invention contemplates applying an amount of syrup sufficient to yield a coated comestible containing about 10% to about 65% coating.

Those skilled in the art will recognize that in order to obtain a plurality of coated layers, a plurality of premeasured aliquots of coating syrup may be applied to the gum center tablets. It is contemplated, however, that the volume of aliquots of syrup applied to the gum center tablets may vary throughout the coating procedure.

Once a coating of syrup is applied to the gum center tablets, the present invention contemplates drying the wet syrup in an inert medium. A preferred drying medium comprises air. Preferably, forced drying air contacts the wet syrup coating in a temperature range of from about 70° F. (21° C.) to about 115° F. (46° C.). More preferably, the drying air is in the temperature range of from about 80° F. (27° C.) to about 100° F. (38° C.). The invention also contemplates that the drying air possesses a relative humidity of less than about 15 percent. Preferably, the relative humidity of the drying air is less than about 8 percent.

The drying air may be passed over and admixed with the syrup coated gum centers in any way commonly known in the art. Preferably, the drying air is blown over and around or through the bed of the syrup coated gum centers at a flow rate, for large scale operations, of about 2800 cubic feet per minute. If lower quantities of material are being processed, or if smaller equipment is used, lower flow rates would be used.

The present invention also contemplates the application of powder material after applying an aliquot of coating syrup to help build up the coating.

For many years, flavors have been added to a sugar coating of pellet gum to enhance the overall flavor of gum. These flavors include spearmint flavor, peppermint flavor, wintergreen flavor, and fruit flavors. These flavors are generally preblended with the coating syrup just prior to applying it to the core or added together to the core in one or more coating applications in a revolving pan containing the cores. Generally, the coating syrup is very hot, about 130° F. (54° C.) to 200° F. (93° C.), and the flavor may volatilize if preblended with the coating syrup too early.

The coating syrup is preferably applied to the gum cores as a hot liquid, the sugar or polyol allowed to crystallize, a dry charge added and the coating then dried with warm, dry air. Aliquots of syrups are preferably applied in about 30 to 80 applications to obtain a hard shell coated product having an increased weight gain of about 25% to 75%. A flavor is applied with one, two, three or even four or more of these coating applications. Each time flavor is added, several non-flavored coatings are applied to cover the flavor before the next flavor coat is applied. This reduces volatilization of the flavor during the coating process. Dry charge is not used when flavor is applied. For mint flavors such spearmint, peppermint and wintergreen, some of the flavor components are volatilized, but sufficient flavor remains to give a product having a strong, high impact flavor. Fruit flavors, that may contain esters, are more easily volatilized and may be flammable and/or explosive and therefore, generally these types of fruit flavors are not used in coatings.

### EXAMPLES

The following gum formula was made in production equipment to prepare 1.0 gram pillow shaped chewing gum cores for coating:

| | |
|---|---|
| Gum Base | 30.0% |
| Calcium Carbonate | 14.8% |
| Sorbitol | 45.0% |
| Glycerin | 4.0% |
| Wintergreen-menthol flavor | 3.2% |
| Encapsulated sweeteners | 1.9% |
| Sweetener | 0.1% |
| Water | 1.0% |
| Total | 100.0% |

A quantity of centers were then coated in a Driacoater 2000 using first and second coating syrups, a blend of flavor and menthol, and a dry charge as follows:

| Ingredient | First Syrup | Second Syrup |
|---|---|---|
| Water | 15.90% | 22.01% |
| Maltitol powder | 63.32% | 67.03% |
| Gum Talha (40% wt solution) | 19.35% | 10.00% |
| Titanium Dioxide | 0.84% | 0.96% |
| Sweetener | 0.59% | — |

For the first syrup, a 40% gum talha solution was prepared at 160° F. and added to an 80% maltitol solution at about 167° F. To this was added a titanium dioxide slurry and powdered high intensity sweetener and held at about 167° F. This first syrup was about 72° Brix.

The second syrup was prepared by mixing half the amount of 40% gum talha solution with a 75% maltitol solution at about 167° F. Titanium dioxide was added similarly, but no sweetener was added. This second syrup was about 71° Brix.

Flavor and menthol were blended together before being used in the coating.

Calcium carbonate was mixed 50/50 with maltitol fine powder and used as the dusting mix for the dry charge coating.

A 1250 Kg quantity of gum centers was added to the Driacoater 2000. After a three minute dedusting phase, gum was coated with eight applications of the first syrup and, after each application, was dry charged with the dusting mix at a level of about 1 pound per 2 pounds of liquid syrup. After each of the next eight syrup applications, dry charge was applied at a level of about 1 pound for 10 pounds of syrup. In the next two syrup applications, the level of syrup was cut in half and applied in equal portions before and after the flavor, which was applied in two applications. No dry charge was used when flavor was applied.

After this, 10 more applications of syrup were applied and after each a dry charge was applied at a level of 1 pound for each 10 pounds of syrup. Again the flavor was applied as previously with two syrup applications. After this, 10 more syrup applications using the second syrup were made with air drying, but no dry charge was used. In each of the next three syrup applications of the second syrup, the level of syrup was reduced and the drying air reduced to give a smooth coating. Coating was completed when a piece weight of 1.56 grams was reached. After the coating was complete, the product was polished with carnauba wax and talc.

The resulting coating had the following composition.

| | Comparative | Inventive |
|---|---|---|
| | Example A | Example 1 |
| Maltitol powder* | 76.4% | 76.4% |
| Gum Talha | 6.7% | 6.7% |
| Maltitol fine powder** | 12.2% | 6.1% |
| Calcium carbonate*** | — | 6.1% |
| Titanium Dioxide | 1.8% | 1.8% |
| Flavor/menthol | 2.0% | 2.0% |
| Sweetener | 0.9% | 0.9% |
| | 100.0% | 100.0% |

*Particle size of maltitol powder was 5% max retained on 35 mesh screen and 40% minimum retained on 140 mesh screen. In the inventive Example 1, this maltitol was mixed with water to make the coating syrup
**Particle size of maltitol fine powder was 2% max retained on 100 mesh screen and 70% Max passing through a 325 mesh screen. This maltitol was mixed 50/50 with calcium carbonate and used as the dusting mix for the dry charge during coating in Comparative Example A.
***Particle size of calcium carbonate used as the dusting mix for the dry charge coating in Inventive Example 1 was 100% through 325 mesh screen.

In another example of adding a high level of calcium carbonate to the dry charge coating, the following gum center formula was made:

| | |
|---|---|
| Gum Base | 33.0% |
| Calcium Carbonate | 13.0% |
| Sorbitol | 46.4% |
| Glycerin | 4.0% |
| Peppermint-menthol flavor | 2.3% |
| Lecithin | 0.5% |
| Encapsulated sweetener | 0.7% |
| Sweetener | 1.0% |
| Total | 100.0% |

A 1250 Kg quantity of centers was then coated in a Driacoater 2000 using the following syrups.

| Ingredient | Third Syrup | Fourth Syrup |
|---|---|---|
| Water | 16.01% | 22.18% |
| Maltitol Powder | 54.28% | 57.27% |
| High maltitol content syrup (dry | 9.57% | 10.10% |
| solids) | | |
| Gum Talha (40% wt solution) | 19.55% | 10.01% |
| Titanium Dioxide | 0.46% | 0.44% |
| Sweetener | 0.13% | — |

Gum centers were coated using the procedure given in the examples above (using the third syrup in place of the first syrup and the fourth syrup in place of the second syrup) with the dry charge added after each liquid addition for the first 26 coating applications, except where flavor was added. The high maltitol content syrup (88% maltitol on a dry basis) was used to replace some of the maltitol powder in the liquid coating syrups. The high maltitol content syrup acts as a binder in the coating formula, and this allows for a lower usage of gum talha. The coating had the following overall composition:

| | Comparative | Inventive |
|---|---|---|
| | Example B | Example 1 |
| Maltitol powder* | 68.3% | 68.7% |
| High maltitol content syrup | 12.1% | 12.1% |
| Gum Talha | 5.0% | 4.3% |
| Maltitol fine powder* | 12.1% | 6.2% |
| Calcium carbonate* | — | 6.2% |
| Titanium Dioxide | 0.9% | 0.9% |
| Flavor/menthol | 1.3% | 1.3% |
| Sweetener | 0.3% | 0.3% |
| | 100.0% | 100.0% |

*Maltitol powders and calcium carbonate have same particle size as Examples A and 1.

Example 1 compared to Example A was not only lower in cost due to replacing part of the maltitol with calcium carbonate, but also gave a faster coating time and improved the quality of the pellets with more corner strength with less chipping, and improved shelf life.

Example 2 compared to Example B was not only lower in cost due to replacing part of the maltitol with calcium carbonate, but improved product quality. The high maltitol content syrup used in Example B gave an improved corner strength compared to Example A and showed less chipping than Example A, but in so doing gave a less crunchy coating with a poorer shelf life. The added calcium carbonate in the dry charge of Example 2 gave a shorter coating time and increased the pellet crunch, while improving the corner quality and improving the shelf life.

As noted above, the use of a high quantity of filler in the dry charge not only reduced the cost of the coating, it was surprisingly found to improve the coating quality, such as a cruncher coating, increased corner strength and improved shelf life. A quality coating is one that has a strength sufficient to prevent the corners from chipping during normal manufacturing and distribution of the coated pellets. Other aspects of a high quality coating include smoothness, uniform color, and retaining the shape of the underlying core.

The use of filler in the dry change also makes possible the use of a high maltitol content syrup in the coating syrup, such as in Example 2. This material is lower in cost and more readily available than high purity maltitol powder. As noted above, the use of a high maltitol content syrup (over 80% of the solids being maltitol) gives improved corner strength of pellets during processing, but gives a product with a shorter shelf life. This syrup contains about 3% sorbitol and a small quantity of higher molecular weight hydrogenated oligosaccharides. It is believed that a specific level of about 1-4% sorbitol in the coating syrup and possibly a low level of higher MW hydrogenated oligosaccharides may yield a product that will have both good corner strength for processing, while still giving a product with good product shelf life. The use of this type of syrup may have advantages in making coated products even when a dusting mix with a high filler content is not used. Comparative Example B above may thus be an example of this additional invention.

It should be appreciated that the methods of the present invention are capable of being incorporated in the form of a variety of embodiments, only a few of which have been illustrated and described above. The invention may be embodied in other forms without departing from its spirit or essential characteristics. The described embodiments are to be considered in all respects only as illustrative and not restrictive, and the scope of the invention, therefore, indicated by the appended claims rather than by the foregoing description. All changes that come within the meaning and range of equivalency of the claims are to be embraced within their scope.

1. A method of forming a sugarless coating on chewing gum cores comprising:
a) providing chewing gum cores;
b) providing a coating syrup comprising one or more sugarless sweeteners;
c) providing a dusting mix comprising about 20% to about 60% of a bulk sweetener selected from the group consisting of malitol, hydrogenated isomaltulose, lactitol, sorbitol and mixtures thereof and about 40% to about 80% filler;
d) applying a plurality of layers of the coating syrup and a plurality of layers of the dusting mix to the chewing gum cores to form a sugarless coating on the gum cores.

2. The method of claim 1 wherein the coating syrup and dusting mix are applied alternatingly for at least 12 coating operations.

3. The method of claim 1 wherein the filler comprises between about 45% and about 55% of the dusting mix.

4. The method of claim 1 wherein the dusting mix comprises about 50% filler and about 50% malitol.

5. The method of claim 1 wherein the coating comprises between about 5% and about 10% filler.

6. The method of claim 1 wherein the coating comprises about 6% to about 7% filler.

7. The method of claim 1 wherein the syrup comprises between about 30% and about 80% of a sugarless sweetener selected from the group consisting of malitol, sorbitol, hydrogenated isomaltulose and lactitol.

8. The method of claim 1 wherein the syrup further comprises between about 1% and about 12% of a gum selected from the group consisting of gum arabic, gum talha and mixtures thereof.

9. The method of claim 1 wherein the filler is selected from the group consisting of calcium carbonate, magnesium carbonate, talc, ground limestone, magnesium silicates, aluminum silicates, titanium dioxide, mono-, di-, and tricalcium phosphates, cellulose polymers and combinations thereof.

10. The method of claim 1 wherein the filler comprises calcium carbonate.

11. The method of claim 1 further comprising the steps of providing flavor and applying the flavor so as to be incorporated into the coating on the gum cores.

12. The method of claim 11 wherein the flavor is added between application of the coating syrup and no dusting mix is applied between the applications of coating syrup just before and just after the flavor is applied.

13. The method of claim 1 wherein first and second different coating syrups are provided and the different coating syrups are used at different times in the coating operation.

14. The method of claim 1 wherein the coating syrup comprises a high maltitol content syrup.

15. The method of claim 1 wherein the coating further comprises a high-intensity sweetener.

16. The method of claim 1 wherein the coating syrup comprises a high-intensity sweetener.

17. The method of claim 1 wherein the coating comprises a hard shell coating.

18. The method of claim 1 wherein the chewing gum cores have a pellet shape with corners and the coating has a strength sufficient to prevent the corners from chipping during normal manufacturing and distribution of the coated pellets.

19. A method of forming a sugarless coating on chewing gum cores comprising:
a) providing chewing gum cores;
b) providing a coating syrup comprising maltitol;
c) providing a dusting mix comprising about 45% to about 55% malitol and about 45% to about 55% calcium carbonate;
d) applying a plurality of layers of the coating syrup and a plurality of layers of the dusting mix to the chewing gum cores to form a sugarless coating on the gum cores.
